(19) United States
(12) Patent Application Publication
(10) Pub. No.: US 2009/0148398 A1
(43) Pub. Date: Jun. 11, 2009

(54) Naturally Occurring Volatile Attractant

(76) Inventors: Robert K. Vander Meer, Newberry, FL (US); Catherine Preston, Gainesville, FL (US); Yasmin Cardoza, Raleigh, NC (US)

Correspondence Address: USDA, ARS, OTT, 5601 SUNNYSIDE AVE, RM 4-1159, BELTSVILLE, MD, 20705-5131, US

(21) Appl. No.: 11/952,246

(22) Filed: Dec. 7, 2007

(51) Int. Cl. A01N 43/60; A01P 7/04

(52) U.S. Cl. 424/84

(57) ABSTRACT

A bait composition for the control of fire ants based on fact that an ant pyrazine attractant contained therein will attract foraging fire ants and the fire ants will be stimulated by the phagostimulant to eat the bait and distribute active ingredients also contained therein throughout the colony. Furthermore, the bait composition can be used directly or modified as a surveillance composition for monitoring and detecting fire ants based on the fact that a pyrazine attractant contained therein will attract foraging fire ants to a trap containing a fast acting, non-repellent insecticide that keeps attracted workers in the trap as a measure of fire ant presence.

### BACKGROUND OF THE INVENTION

1. Field of the Invention

The present invention relates to an improved attractant composition for use in bait compositions and/or traps for social insects, particularly ants and more particularly fire ants. It also relates to the use of these compositions to control and/or monitor pest social insects. Furthermore, the present invention also relates to the use of these compositions to decrease the quantity of insecticide required to control pest social insects.

2. Description of the Related Art

Discovering pesticides that are effective against a broad range of insect pests and that can be used safely has long been a problem. One such problem area has been in the control of social insects such as ants, yellow jacket wasps, other pest wasps and termites. Various species of ants pose significant problems for man from both an agricultural and a health care point of view. Leaf-cutting ant species can defoliate a citrus tree overnight. Argentine ants endanger crops by domesticating and protecting other pest insects such as aphids and scale. Fire ants are particularly destructive by stinging humans and livestock, feeding on germinating seeds and crop seedlings thereby reducing yields, damaging electrical equipment and damaging farm machinery that run into ant mounds.

Requirements for an effective pesticide formulation for the control of pest social insect species, such as ants, are very stringent because the reproductive forms (queens) of social insects are buffered from the effects of insecticides by a large worker force and their often closed nest structure. Thus, control of social insect pests is inherently different from control of non-social insects. For example, mature monogyne (single queen) fire ant colonies may, contain up to 250,000-sterile workers and reach infestations rates of 130 mounds per hectare. Only 10 percent of the workers are on the surface foraging for food. Insecticide treatment with a fast acting insecticide will not affect the 0.90% of the workers in the nest or the queen and the total effect is negligible. In fact, 95% of the workers can be killed, but if the queen is unaffected, the colony will come back.

In the last decades polygyne fire ant colonies (multiple queen colonies) have proliferated. The number of mounds in polygyne populations reach over 500 per hectare and because colonies of this social form are not territorial, the populations are composed of interconnected colonies that exchange workers, queens, and resources, (the population behaves as a unicolony). Control of polygyne population is difficult because of the higher worker densities and more queens must be killed.

In view of the above, an effective social insect toxicant must exhibit delayed toxicity, not repel the insects and be effective over a range of concentrations. Repellency can reduce or negate the effectiveness of a toxicant because the insects will avoid the toxicant-containing composition. The toxicant must be presented in a form that is transferable either by carrying it back to the nest or by trophallaxis (regurgitating food from one worker to another) and the toxicity must be delayed because foraging worker insects constitute only a small percentage of the total colony and must survive long enough to pass the toxicant onto the main colony population, especially the queen(s).

Attractants, for insect control, are used to lure insects, to a toxicant and/or trap and they can be used to identify the presence, distribution and population of an insect. Attractants facilitate the discovery and transfer of toxicant to a pest social insect nest so that it is passed onto the main colony population, including the queens.

There are many commercial products available for fire ant control, e.g., drenches, residuals, and baits. Baits are the more environmentally acceptable of the three broad categories. Baits rely on the natural foraging ability of fire ants and are composed of: (a) the active Ingredient (AI) that must exhibit a delayed activity in order to give the foraging workers time to distribute the AI to other members of the colony; (b) a phagostimulant vegetable oil, e.g., corn oil, soy bean oil, canola oil, peanut oil, olive oil, etc. that also acts as a solvent for the AI; and (c) an inert carrier typically pre-gel defatted corn grits (absorbs 30% if its weight in oil, yet maintains flow ability).

Foraging fire ant workers randomly find the bait particles (the phagostimulant oil does not attract the ants, it only stimulates them to feed) and effectively suck the oil/AI out of the particle, or they bring the bait back to nest mates, or they recruit additional workers to the bait. The efficacy of control via toxic bait is largely dependent on the foraging efficiency of the ant species involved. On a two-dimension surface the fire ant would be extremely efficient at finding and retrieving bait particles however, the three dimensional foraging habitat (matted grass, pasture, etc) is extremely complex even for an efficient forager like the fire ant which finds only a portion of the baited particles. Because of this, the fire ant baits, e.g., Amdro® (AI-Hydramethylnon), are typically formulated with 20-30 times the amount of active ingredient necessary to kill a colony if that colony received all the toxic bait targeted to it via an EPA approved label. This helps to level out the variation in the amount of bait recovered, environmental conditions etc, and importantly gives the end user more consistent results.

If the fire ant finds more bait, then the amount of the active ingredient and/or the amount of bait/unit area can be reduced without affecting the result. If more bait gets to the target, then less bait is available for non-targeted species. Non-target ants are typically excellent predators of newly mated fire ant queens and thus are desired species. In an area that is treated for fire ants, and both fire ants and non-target ants are greatly reduced, then the ant-species vacuum produced is quickly repopulated by fire ants whose mating flight-colonization capabilities (from the area surrounding the treated area) are huge (5,000 sexuals per year per colony) compared with native ant species. Ideally one wants to treat for fire ants and leave the non-target ant species unaffected and available as predators of newly mated fire ant queens, resulting in a reduced re-infestation rate. An enhanced-targeted bait can achieve such an objective.

The fire ants, Solenopsis richteri and Solenopsis invicta, Red and Black imported fire ants, respectively, were inadvertently introduced into the United States in the early 1900's at the port of Mobile, Ala. From this early foothold, they spread throughout the southern states primarily via transport of queens or incipient colonies in nursery stock. In 1949, infestations were known to occur in 28 counties in Alabama, Florida and Mississippi. Four years later, after a survey of nurseries throughout the south, infestations had been detected in 102 counties in 10 states. Once established at these sites, the fire ants spread rapidly through their normal mating flights so that by 1983 about 230,000,000 acres were infested in 9 states and Puerto Rico. Currently there are over 130 million hectares infested in 14 Southern States from California to Virginia. Within the past decade S. invicta has also become established in Australia, Taiwan and China.

To add to the complexity of the IFA problem, polygynous (multiple queen) colonies are becoming increasingly abundant throughout their range, S. richteri and S. invicta hybridize, producing reproductibly viable colonies.

With the spread of fire ants came an increasing awareness that they cause numerous problems ranging from medically-related concerns associated with their stings and associated venom, to agronomic losses because of interference with farming operations, destruction of crops and injury or death of young animals. The extent of these problems on farms was not obvious early on because of the wide scale use of chlorinated hydrocarbon insecticides from 1950 to 1970. Because of environmental concerns, registrations for these highly effective residual insecticides were cancelled with the result that populations of the IFA on farms increased dramatically. In a 1987 survey of soybean fields in 6 states, it was revealed that there was an average mound density of 50 per acre. The potential impact of these general infestations is immense when it is considered that published data show potential losses of 5-6 bushels of soybeans per acre associated with the ant densities cited above.

Similar problems have been shown to occur in other agronomic crops in the South. IFA densities as high as 200 mounds per acre have been recorded in young citrus groves. (1 to 4 years old). The fire ants score the tree's bark and feed on sap from the wound. Eventually they girdle the tree and it dies-up to 15% of them have been reported to be killed. Based upon estimated costs published by the University of Florida citrus specialists, replacement of these trees would amount to about $1,000 per acre. Imported fire ants also opportunistically tend and protect aphid and scale insects against their predators and parasites, including released biocontrol agents. These insects are pests of citrus, pecans, and many other important commodities.

Imported fire ants have been estimated to cause ca. 5 billion dollars of annual expenditures associated with the damage they cause and the cost of their control. Because of the ant's huge economic impact, it is imperative to improve on current control technologies and develop sensitive easy to use monitoring tools.

The detection of incipient infestations is complicated by the fact that the ants either do not build mounds, or if they do, the ants build mounds that are very small. The workers do not fly, so survey traps based on flight are not feasible. Thus, the only practical approach is to look for infestations after mounds are built or to develop attractant compositions for baits and/or traps for the foraging workers. The use of an attractant composition is practical since IFA have an extremely effective foraging system that involves a series of underground tunnels with exit holes to the surface every 15 to 20 inches.

While baits are currently available for control of social insect pests, for instance as disclosed in U.S. Pat. No. 6,344,208 herein incorporated by reference; there remains a need in the art for highly effective attractants to improve baits for the control of social pest insects. The '208 patent reports a natural alarm pheromone of ants is unsuitable for use as a bait for subsequent incorporation in the nest. The patent reports, “[t]he concept of alarm pheromones in general implies that they are totally inappropriate substances for use in food baits as such baits would then be treated as aliens or enemies and attacked and removed.”

The present invention provides a natural or synthetic volatile attractant for baits and/or traps effective for controlling fire ant populations which is different from the related art.

### SUMMARY OF THE INVENTION

In order to overcome the limitations as above discussed it is therefore, an object of the present invention to provide volatile natural or synthetic attractant-containing baits for the control of fire ants.

Another object of the present invention is to provide a volatile attractant composition in a matrix which further includes a toxicant and a phagostimulant.

A further object of the present invention is to provide a volatile fire ant produced pyrazine compound or composition as an attractant in a bait wherein the bait also contains a toxicant and a phagostimulant.

Still another object of the present invention is to provide a trapping system that includes a volatile fire ant produced pyrazine attractant compound or composition.

A further object of the present invention is to provide a t-rapping system that includes a fire ant produced pyrazine attractant compound or composition as an attractant.

A still further object of the present invention is to provide a fire ant produced pyrazine attractant compound or composition added to oils used in baits as phagostimulants and to solvents in order to increase the attractiveness of such compositions to pest insects.

Another object of the present invention is to provide a method for controlling fire ants that includes a fire ant produced pyrazine attractant compound or composition as an attractant in a bait formulation.

Further objects and advantages of the present invention will be apparent from the following detailed description.

### BRIEF DESCRIPTION OF THE DRAWINGS

FIG. 1 shows results of S. invicta worker response to pyrazine in Y-tube olfactometer assays.

FIG. 2 shows percent (mean±SE) of worker ants that ingested oil from the bait particles of the indicated treatment (pyrazine or control) by directly sucking the oil from the bait particles or through food exchange (trophallaxis) with workers that had already ingested corn oil from the bait particles or from trophallaxis. Oil soluble dyers were used as markers for corn oil ingestion. Both refers to ants that had ingested corn oil from both pyrazine and control grits. Total % Fed is the percent workers that ingested oil from the presented grit particles-pyrazine, control, or both (counted only once).

FIG. 3 shows a comparison of the amount of corn oil removed from bait particles where a blue or red dye marker has been added to the corn oil. In addition, one pair of red and blue dyed bait had attractive quantities of the pyrazine added to it and the other pair of blue and red dyed bait particles was the control. The objective was to determine if the color dye and/or the addition of pyrazine had a negative or positive effect on the amount of corn oil removed by the ants.

FIG. 4 shows a comparison of the amount of corn oil removed from bait particles where one pair of red and blue dyed bait had attractive quantities of the pyrazine added to it and the other pair of blue and red dyed-bait particles was the control. The objective was to determine if the addition of pyrazine had a negative or positive effect on the amount of corn oil removed from the bait particles by the ants.

FIG. 5 is a drawing of a Y-tube olfactometer 10 used, in an olfactometer bioassay for detecting attractant substances for insects showing air inlet tube 12, sample chamber 14, baffle 16, ring seal tube (front) 18, ring seal tube (rear) 20 and entrance stem 22.

### DETAILED DESCRIPTION OF THE INVENTION

The present invention is not based on the fact that alarm pheromones are totally inappropriate substances for use in, food baits because fire ants would treat the substance as an alien or enemy. Rather the present invention is based on fact that the pheromone will attract fire ant workers to the bait particles where upon contact with the bait phagostimulant will induce workers to consume the bait and distribute active ingredients throughout the colony.

The term enhanced bait for the purposes of this disclosure is understood by those skilled in the art to be a combination of ingredients including an attractant, a phagostimulant, an insecticide and a suitable carrier.

The term “attractant” for the purposes of this disclosure includes substituted pyrazines. Particularly dimethyl pyrazines and more particularly 2-ethyl-3,5-dimethyl pyrazine and 2-ethyl 3,6-dimethyl pyrazine. These compounds are present in the bait composition either together or alone in amounts effective to attract social pest insects to the bait. For fire ant attraction, pyrazines can be used in a concentration range of from about 0.0003% to about 0.0.1% (wt:v) for granular baits. More preferred is about 0.03 (wt:v). For monitoring traps, the concentration range is about 0.0003, to about 0.1% (wt:v). One of ordinary skill in the art could readily determine optimal concentration ranges for the attraction of any pest social insect.

Amounts effective to attract social insects, including ants is defined as that amount which increases attraction of an insect compared to a control that does not contain the attractant of the present invention.

For baits, the solvent for the attractant can be, for example, a vegetable oil or other liquid food related products. For traps, the solvent for the attractant may be a food related products as well as mineral oil or other non-repellent attractant solvent. The attractant may also be held and released from a solid, gel, or liquid controlled release matrix.

The phagostimulant or bait may be any substance that will entice the insect to ingest the toxicant. Suitable phagostimulants include edible oils and fats, vegetable seed meals, meal by-products such as blood, fish meal, syrups, honey, sucrose and other sugars, peanut butter, cereals, amino acids, proteins, etc. See U.S. Pat. No. 3,220,921 which is herein incorporated by reference. Preferred phagostimulants for ants are mixtures of edible oils and/or fatty acids, which are also solvents for toxicants.

Nonlimiting examples of suitable carriers include, for example, corncob grits, pregel defatted corn grits (PDCG), diatomaceous earth, alumina, silica, clays, other suitable inorganic oxides, polymers, extruded corn, powdered carbohydrates such as corn starch, dextrans and cellulose; and the like. Preferred carriers include pre gel defatted corn grits.

The active ingredient can be any substance which kills or inhibits the reproductive capabilities of the pest social insect. Unlimited examples of active ingredients suitable for use with the attractant composition of the present invention include for example, organophosphates, carbamates, arsenicals, pyrethroids, insect growth regulators, boric acid, silica gel, and borate as disclosed in U.S. Pat. No. 5,104,658, which is herein incorporated by reference. See also, for example, U.S. Pat. No. 5,177,107; herein incorporated by reference.

The active ingredient is present in amounts effective for controlling pest social insects as long as it is not repellent to the targeted insect when it is incorporated into the attractant composition.

The attractant of the present invention can be combined with phagostimulant and toxicant and applied to a carrier by any appropriate means. For example, a solid carrier can be soaked with the phagostimulant and toxicant containing the attractant composition resulting in a solution or suspension wherein the bait solution containing the attractant is deposited or impregnated into said carrier material. The treated carrier material can then by applied by spraying the area or object to be treated; by broadcasting, by applying to cracks and crevices, and by applying a gel; for example.

The attractant composition of the present invention can be used in a trap by dissolving attractant in a non-volatile and non-ant repellent solvent, such as, for example, mineral oil or ethylene glycol. This solution can then be placed in a pitfall trap vial that is placed in the ground such that the lip of the vial is level with the soil surface. Ants attracted to the solution, will fall into the trap and be preserved in the solvent. Another manifestation of the attractant trap is the attractant dissolved in a non-volatile and non-ant repellent solvent, and placed in a trap system that incorporates a non-repellent fast acting insecticide that will keep attracted ants in the trap. The attractant can also be formulated into a controlled release matrix that attracts ants.

As is typical of social insects, fire ants rely heavily on chemical communication and there are a number of well-established releaser pheromones, such as alarm, queen, and recruitment pheromones. The U.S. Pat. No. 6,344,208 patent (supra) discloses the following synthetic alarm pheromone components nonanol, decanal dodecanal, 2-phenylethanol, citral, farnesol, 6-methyl-5-hepten-2-one, 4-methyl-3-heptanone, decanoic acid, geraniol, tetradecanal or β-pinene.

Recently, the identity of a component of the fire ant alarm pheromone was determined to be 2-ethyl, 3,6-dimethyl pyrazine and the origin is the mandibular gland. This compound elicited the full range of previously reported fire ant alarm behaviors (Alonso, L. E. and Vander Meer, R. K., Source of alate excitant pheromones in the red imported fire ant, Solenopsis invicta (Hymenoptera: Formicidae), J. Insect Behavior, Volume 10, 541-555, 1997) including heightened alertness and rapid movement. In addition, 2-ethyl, 3,6-dimethyl pyrazine is commercially available as a mixture with the related compound, 2-ethyl, 3,5-dimethyl pyrazine. Both compounds elicit an alarm response, but, fire ant workers responded better to 2-ethyl, 3,6-dimethyl pyrazine.

All ants used in these experiments were obtained from mature, queenright, monogyne Solenopsis invicta colonies excavated from a known monogyne site in Gainesville, Fla. The colonies were separated from the dirt and set up in the laboratory at least one month prior to the experiments. Laboratory colonies were maintained on a diet of crickets, water and 10% sucrose, and kept in plastic trays (83×53×13 cm) whose inner sides were painted with poly tetrafluoroethylene compositions (ADI Fluon, ICI Americas, Bayonne, NF) to prevent, escape of the ants.

### EXAMPLE 1

### Quantification of Pyrazine in Fire Ant Mandibular Glands

It is important to know the amount of 2-ethyl-3,6-dimethyl pyrazine stored in fire ant mandibular glands, in order to know what quantity of the pyrazine is physiologically relevant. Solenopsis invicta major workers were randomly selected from 5 queenright colonies. Ants were placed in disposable plastic 10 ml test tubes and immediately immersed in a Dry Ice/acetone bath. Ants were kept in the Dry Ice/acetone bath until needed for dissections. Mandibles were pulled out of the severed head without water, and under a stereomicroscope. Individual mandibles with mandibular glands and associated musculature were immediately transferred to a 1.5 ml Gas Chromatograph (GC) autosampler vial fitted with a 200 μl conical glass insert containing 30 μl hexane (99.9% HPLC grade, Fisher Scientific, Fairlawn, N.J.). The mandibular gland was not separated from the mandible or musculature because the gland is very small and the gland and its contents would not survive the additional time and manipulations. Twenty mandibles and glands were accumulated in each insert from each colony sampled. The autosampler vials were stored at −80° C. freezer until analyzed.

Samples were analyzed using an Agilent 6890N gas chromatograph equipped with a split/splitless injector (splitless mode, 250° C., injection volume 2 μl) interfaced to an Agilent 5973 mass selective detector operated in electron impact mode. Compounds were separated on a J&W DB-23 (30 m×0.32 mm×0.25 μm film thickness) column held at 40° C. for 2 min, then programmed at 5° C./min to 1-25° C., followed by 25° C./min to 250° C. Helium was used as the carrier gas at a constant flow of 1.7 ml/min. Pyrazine analysis specificity and sensitivity were increased using specific ion monitoring (SIM; fragment ions 56.1, 107, 108, 121.1, 135.1, 136.1, and 137.1 are specific to 2-ethyl-3,6-dimethyl pyrazine). Quantification of pyrazine in mandible-mandibular gland-extracts was achieved by comparing the SIM response to that of a standard curve using a commercially available mixture of 2-ethyl, 3,5-dimethyl pyrazine; and 2-ethy, 3,6-dimethyl pyrazine.

The compound 2-ethyl-3,6-dimethyl pyrazine was found in all S. invicta mandibular samples. The amounts of the compound ranged from 59.2-0.251 pg with a mean (SE) of 118.9 (34.22) pg/ant. In addition, nonanal was found in all samples ranging from 173.6-1463.2 pg with a mean (SE) of 529.9 (2337.37) pg/ant. Variation is not surprising since both compounds are highly volatile and are readily lost during the dissection process.

### EXAMPLE 2

### Olfactometer Evaluation of Commercially Available 2-ethyl, 3,5-dimethyl pyrazine and 2-ethyl-, 3,6-dimethyl pyrazine

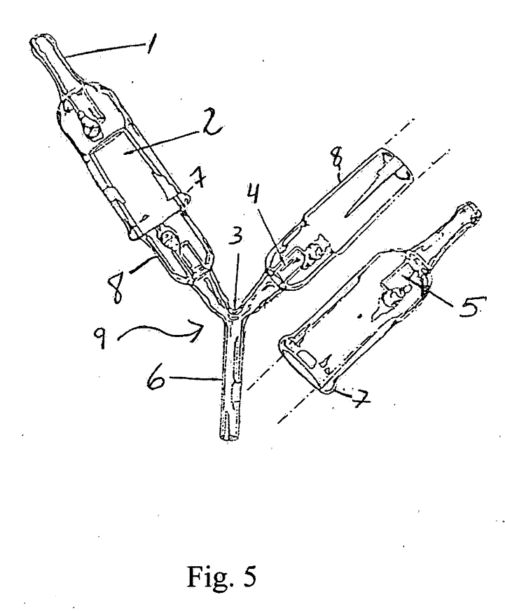

Based on the above, the attraction of S. invicta workers to various concentrations of the commercially available mixture of 2-ethyl, 3,5-dimethyl pyrazine and 2-ethyl, 3,6-dimethyl pyrazine was evaluated using a Y-tube olfactometer (FIG. 5). The olfactometer is composed of two 24/40 ground glass joints 14 each ring sealed to one of the arms 24 of an approximately 5 cm Y-tube 26 such that about 1 cm of each Y-tube extends through the male half of one of the ground glass joints. An approximately 5 cm piece of about 0.6 cm tubing is ring sealed about 1 cm into the female half of the ground glass joints. A baffle 16 at the center of the Y-tube controls air streams and prevents premature mixing of the sample, and gives the ants a clearer choice. Baffle 16 also narrows the openings to the choice chambers 14 to the minimum size required for passage of a major worker. Compressed air (breathing air quality) is split into two streams and passed into the two chambers 14. Each stream is regulated to about 0.2 liters/minute for a total effluent flow-rate of about 0.4 liters/minute.

The highly volatile pyrazine mixture was dissolved in light mineral oil to slow the release rate. Concentrations of 1, 3, 10, 30, and 100 ng/μl were tested against a light mineral oil control. Each treatment and control (1.5 ul) was applied to a piece of filter paper (Whatman #1; 1×0.3 cm). Filter paper pieces containing the treatment and control were each placed inside the entrances 15 of one of the two arms of the Y-tube olfactometer connected to the airflow. The main body of the olfactometer was 12 cm long. Ants had to walk about 5 cm upwind before reaching the bifurcation choice point and then had to walk another 2.5 cm before being trapped within the chamber containing the treatment or control. Compressed air was passed through each of the two sample Y-tube arms at a rate of 0.2 L/min (0.4 L/min combined). Approximately 100 worker ants were released at the downwind arm of the Y-tube olfactometer via a piece of tygon tubing (7 cm long×1.0 cm id) closed at the distal end with a wire mesh cap.

Due to the volatility of the pyrazines, the experiments were terminated after 3 minutes. The number of ants entering the chamber with either the control or the treatment during the 3 min were counted and recorded. The experiment was replicated 6 times, with each replicate representing different colonies. All colonies were tested against each of the pyrazine concentrations. The S. invicta queen attractant found in the poison sac was used as a positive standard (0.33 queen poison sac equivalents per 10 μl hexane) to test proper function of the olfactometer.

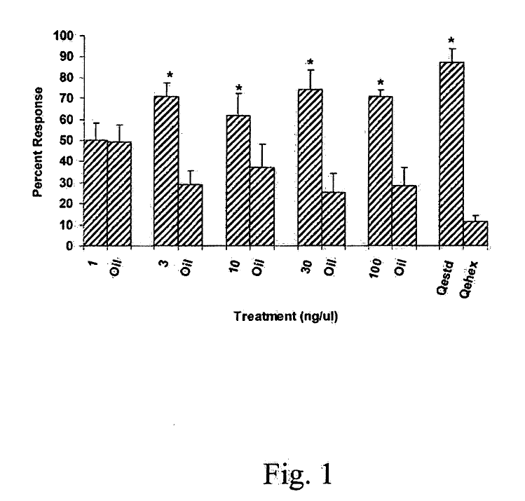

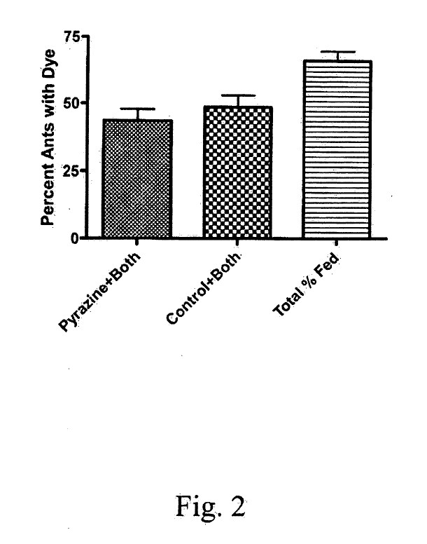

All concentrations of pyrazine, except for the 1 ng/μl significantly attracted more S. invicta workers than the mineral oil control (paired t-test, P≦0.05) (FIG. 1). The highest response (74.5%) was obtained with 30 ng/μl and the lowest (50.8%) with the 1 ng/μl. The response to the 30 ng/μl pyrazine concentration was statistically equivalent to that of the queen poison sac positive control, which averaged 88.2% (FIG. 2).

The olfactometer experiment demonstrates that the alarm pheromone component, 2-ethyl, 3,6-dimethyl pyrazine attracts fire ant workers through space, and can therefore be expected to decrease the time it takes for fire ant foragers to discover pheromone enhanced bait particles.

### EXAMPLE 3

### Effect of 2-ethyl, 3,5- and 3,6-dimethyl pyrazine on Bait Oil Uptake and Distribution

To determine if addition of 2-ethyl, 3,5- and 3,6-dimethyl pyrazine to fire ant-bait affects oil distribution or the amount of oil worker ants remove from the bait particles, the following dual-choice feeding experiment was set up. One gram of worker ants was obtained from each of 6 queenright monogyne laboratory colonies. Ants were placed within nest cells made of disposable plastic Petri dishes (0.6×0.5 cm), half-filled with castone. The lid of the dish had a small hole in the center to facilitate ant movement in and out of the cell. After the ants were placed within the cell, the access hole was plugged with a rubber septum to confine the ants until treatment exposure. Ants were deprived of food overnight in preparation for the experiment, but the castone was moistened to prevent dehydration of the worker ants. The nest cells were placed in the center of plastic shoeboxes (29×16×7.5 cm), along with a water tube. The sides of the shoeboxes were painted with Fluon® to contain the ants.

Treatments were prepared by mixing corn oil with 1% calico blue or calico red dye. Each dye was divided in half. One half was amended with 2-ethyl-3,5 (3,6)-dimethyl pyrazine at a concentration of 30 ng/μl. These treatments were mixed with pre-gel defatted corn grits at 80:20 w:w grits/oil. The grits had previously been sieved through a 1.4 mm sieve and those that were >1.4 mm were used. The grit/oil mixture was placed in 50 ml glass jars and were shaken for approximately 15 min to ensure even oil/dye coverage of the particles, and then allowed to sit at room temperature for another 30 minutes. After this equilibration period, 25 grit particles of each treatment/color combination were weighed and then placed on aluminum foil squares (2×2 cm). The treatments were placed on opposite corners of the shoeboxes. Each box received a control and a pyrazine treatment, each of different color, so that if the control was blue, the pyrazine would be red, and vice-versa. After the treatments were in place, the rubber septa were removed from the cell tops to release ants from the nest cells. The response of the ants was observed for 15 minutes to determine discovery. Ants were allowed access to the treatments for 24 h.

Discovery. Ants discovered the pyrazine treatment, regardless of color, faster than the controls. More than 60% (4/6) of the pyrazine baits were found within 30 seconds in contrast to just 16% (1/6) of the controls. All bait treatments were found within 5 minutes after connecting the experiment. Ants removed 100% of the pyrazine treated grits and 85% of the control grits from the aluminum foil.

Oil Distribution. Preferential feeding was evaluated by randomly selecting 100 ants, placing them in the freezer to incapacitate them. Then they were placed between two pieces of white paper and crushed using a heavy metal roller. The number of ants showing red, blue, purple (had blue and red dye), or no color in their crop contents was counted and these numbers were used to determine treatment distribution preference.

Examination of the crushed ant data showed that of the workers sampled the mean (SE) percent of those containing only oil from the pyrazine treatment was 17.5 (2.21). The mean (SE) percent workers containing only oil from the control was 22.9 (2.62), and the mean (SE) percent workers that had ingested oil from both the pyrazine and control was 25.9 (4.25). The mean (SE) percent of workers that had no evidence of dyed oil was 33.7 (3.71). The mean (SE) percent ants ingesting oil from pyrazine baits and control baits are shown in FIG. 2. The pyrazine/corn oil distribution to worker ants was not statistically different from the distribution of control/corn oil to worker ants (P=0.2564).

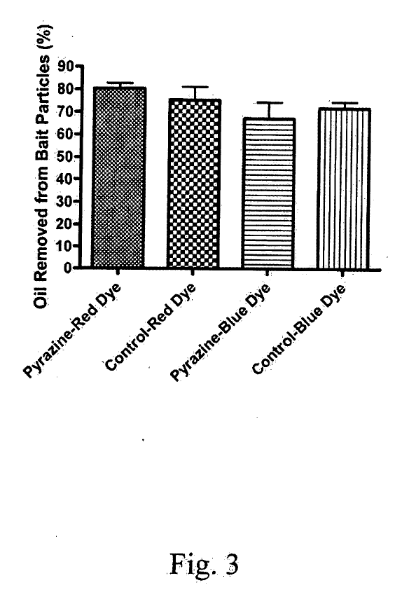

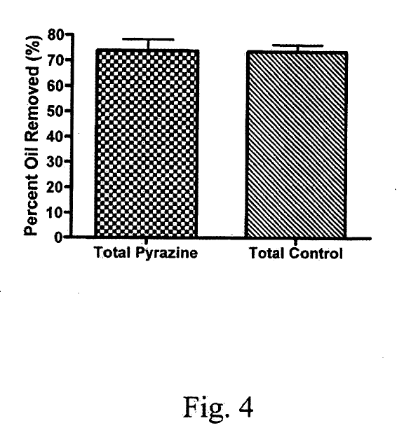

Oil Uptake. Corn oil uptake from the bait particles was determined spectrophotometrically, based on the calico blue and red dyes added to the corn oil bait formulation (see methods). One objective was to determine if the color dye and/or the addition of pyrazine had a negative or positive effect on the amount of corn oil removed by the ants. FIG. 3 shows the mean (SE) percent removed from bait particles where a blue or red dye marker has been added to the corn oil. In addition, one pair of red and blue dyed bait had attractive quantities of the pyrazine added to it and the other pair of blue and red dyed bait particles was the control. There were no significant differences in oil uptake between the pyrazine and control when compared with the same color dye (P=0.55). The mean removal of oil from the bait particles with the red dye was numerically greater than that for the bait particles with the blue dye; however, the differences were not significant. FIG. 4 compares the results for the combined pyrazine versus control oil uptake, regardless of the color dye used. Interestingly, the means (SE) are virtually identical, 71.7 (2-0.08) control and 71.2 (3.82) for the pyrazine treatment. The pyrazine alarm pheromone added to bait particles at attractive concentrations does not negatively or positively affect the phagostimulation effects of the corn oil in the bait particles.

The results above presented show that incorporation of a component of the fire ant alarm pheromone, 2-ethyl, 3,6(and 3,5-)-dimethyl pyrazine does not negatively affect the uptake of oil from the bait particles, nor does it negatively affect the distribution oil to colony nestmates. Therefore, as set forth above forager ants are hard-wired to respond to sequential stimuli. The olfactometer experiment demonstrated that the alarm pheromone component, 2-ethyl, 3,6-& (3,5)-dimethyl pyrazine attracts fire ant workers through space, and can therefore decrease the time it takes for fire ant foragers to discover pheromone enhanced bait particles.

The uptake and distribution experiments demonstrated that the 2-ethyl, 3,6-& (3,5)-dimethyl pyrazine added to: the bait formulation did not negatively affect uptake or distribution of the corn oil. The material cost of adding 2-ethyl, 3,6-(3,5)-dimethyl pyrazine to the bait is less than 0.8 cents per acre.

Those skilled in the art will recognize that this invention may be embodied in other species than illustrated without departing from the spirit and scope of the essentials of this invention. The foregoing discussion is therefore to be considered illustrative and not restrictive. The scope of the invention is only limited by the appended claims.

What is claimed is:

1. A composition for the control of fire ants, comprising a phagostimulant, an insecticide, at least one ant pyrazine attractant and a suitable carrier.

2. The composition of claim 1 wherein the said at least one ant pyrazine attractants are dimethyl pyrazines.

3. The composition of claim 2 wherein the at least one ant pyrazine attractants is selected from the group consisting of 2-ethyl-3,5-dimethyl pyrazine, 2-ethyl 3,6-dimethyl pyrazine, and mixtures thereof.

4. The composition of claim 1 wherein the phagostimulant is selected from the group consisting of edible oils and fats, vegetable seed meals, meal by-products, fish meal, syrups, honey, sugars, peanut butter, cereals, amino acids, proteins, and mixtures thereof.

5. The composition of claim 1 wherein the carrier is selected from the group consisting of corncob grits, defatted corn grits, diatomaceous earth, alumina, silica, clay, inorganic oxides, polymers, extruded corn, powdered carbohydrates, dextrans cellulose, and mixtures thereof; and the like.

6. The composition of claim 6 wherein the carrier is defatted corn grits.

7. A trapping system for monitoring for the presence of fire ants comprising a composition that includes an insecticide, at least one ant pyrazine attractant and a suitable carrier.

8. The trapping system of claim 7 wherein said carrier is a substance, compound, or formulation that increases the active life of the pyrazine attractant, and is selected from the group consisting of corncob grits, defatted corn grits, diatomaceous earth, alumina, silica, clay, inorganic oxides, polymers, extruded corn, powdered carbohydrates, dextrans cellulose, polymers, and mixtures thereof.

9. The trapping system of claim 7 wherein said at least one ant pyrazine attractant is a dimethyl pyrazine.

10. The trapping system of claim 8 wherein the said at least one ant pyrazine attractant is selected from the group consisting of 2-ethyl-3,5-dimethyl pyrazine, 2-ethyl 3,6-dimethyl pyrazine. And mixtures thereof.

11. The trapping system of claim 7 wherein said carrier is a non-volatile and non-ant repellent solvent.

12. The trapping system of claim 10 further comprising a non-volatile insecticide.
